(19) United States
(12) Patent Application Publication
(10) Pub. No.: US 2012/0319914 A1
(43) Pub. Date: Dec. 20, 2012

(54) ANTENNA

(76) Inventor: Masao Sakuma, Kanagawa (JP)

(21) Appl. No.: 13/581,835

(22) PCT Filed: Mar. 11, 2011
(86) PCT No.: PCT/JP2011/055731

§ 371 Date: Aug. 30, 2012

(30) Foreign Application Priority Data
Mar. 12, 2010 (JP) 2010-055302
Mar. 9, 2011 (JP) 2011-051654

(51) Int. Cl. H01Q 9/04

(52) U.S. Cl. 343/790

(57) ABSTRACT

An antenna that can be used in a wide band and can arbitrarily adjust the working frequency band to a higher or lower frequency band includes a resonant conductor tube located on the outside of a feeding section of an unbalanced feed member and covering the feeding section, a ground conductor tube located on the outside of a passive section of the unbalanced feed member and covering the passive section, and a connection conductor guide located between the conductor tubes and the unbalanced feed member. In the antenna, the conductor tubes and the unbalanced feed member are electrically fixed to the connection conductor guide via a fixing unit, and the feeding section of the unbalanced feed member has an exposed portion with a predetermined size, the exposed portion exposed from the resonant conductor tube outward in the length direction thereof.

### TECHNICAL FIELD

The present invention relates to an antenna provided with an unbalanced feed member and a conductor tube disposed on the outside of the outer circumferential surface of the unbalanced feed member.

### BACKGROUND ART

There is an antenna provided with a first waveguide section having a predetermined length and a second waveguide section leading to the first waveguide section and having a predetermined length, the first waveguide section being formed of a core wire of a coaxial cable and a first insulator covering the core wire, the second waveguide section being formed of a first conductor tube fixed to a second insulator of the coaxial cable and a second conductor tube slidably attached to the first conductor tube (see Patent Document 1). This antenna can adjust the length of the second waveguide section in such a way as to enhance the efficiency of the antenna at a communication frequency by moving the second conductor tube with respect to the first conductor tube in the length direction thereof.

Patent Document 1:
Japanese Patent Appln. Laid-Open(KOKAI) No. 2002-100921

### DISCLOSURE OF INVENTION

### Problem to be Solved by the Invention

The antenna disclosed in Patent Document 1 can change the resonance frequency by moving the second conductor tube in the length direction thereof, but the working frequency band (the used frequency band) of the antenna covers only about 10% of the frequency band that can be used as an antenna, making it difficult to expand the working frequency band and impossible to use the antenna in a wide frequency band (a wide band). Moreover, this antenna cannot move the working frequency band thereof to a higher frequency band or move the working frequency band thereof to a lower frequency band.

An object of the present invention is to provide an antenna that can be used in a wide band and can arbitrarily adjust the working frequency band thereof to a higher or lower frequency band.

### Means for Solving Problem

A premise of the present invention to solve the problems described above is an antenna including an unbalanced feed member and a conductor tube disposed on the outside of the outer circumferential surface of the unbalanced feed member, the unbalanced feed member including a feeding section having a predetermined length and a passive section leading to the feeding section and having a predetermined length.

A feature of the present invention based on the above premise is that the conductor tube is formed of a resonant conductor tube located on the outside of the feeding section of the unbalanced feed member and covering the feeding section and a ground conductor tube located on the outside of the passive section of the unbalanced feed member and covering the passive section, the conductor tubes and the unbalanced feed member are electrically fixed via a fixing unit, and the feeding section of the unbalanced feed member has an exposed portion with a predetermined size, the exposed portion exposed from the resonant conductor tube outward in the length direction thereof.

As an example of the present invention, the distance from the inner circumferential surface of the ground conductor tube to the outer circumferential surface of the passive section of the unbalanced feed member is in the range of 8 to 12 mm.

As another example of the present invention, the distance from the inner circumferential surface of the resonant conductor tube to the center of the feeding section of the unbalanced feed member is in the range of 4 to 10 mm.

As another example of the present invention, the distance from the inner circumferential surface of the ground conductor tube to the outer circumferential surface of the passive section of the unbalanced feed member is greater than the distance from the inner circumferential surface of the resonant conductor tube to the center of the feeding section of the unbalanced feed member.

As another example of the present invention, the unbalanced feed member is made of at least first and second conductors and a first insulator of the first conductor, the first insulator covering the outer circumferential surface of the first conductor, the second conductor covering the outer circumferential surface of the first insulator, and a second insulator covering the outer circumferential surface of the second conductor, the feeding section of the unbalanced feed member is formed of the first conductor and the first insulator, and the passive section of the unbalanced feed member is formed of at least the first and second conductors and the first insulator of the first and second conductors and the first and second insulators.

As another example of the present invention, in the feeding section of the unbalanced feed member, a predetermined length of the first conductor is exposed outward from the first insulator in the length direction thereof.

As another example of the present invention, to the first conductor exposed from the first insulator in the feeding section, a third conductor having a predetermined length is electrically fixed.

As another example of the present invention, to the first conductor exposed from the first insulator in the feeding section, a third insulator having a predetermined length is fixed.

As another example of the present invention, the resonant conductor tube, the ground conductor tube, and the exposed portion of the feeding section are covered with a cover member having a predetermined permittivity.

As another example of the present invention, the cover member is made of thermoplastic synthetic resin.

### Effect of the Invention

In the antenna according to the present invention, in-tube resonance is produced in the feeding section and the resonant conductor tube covering the feeding section and resonance is produced in the passive section and the ground conductor tube covering the passive section, making it possible to obtain a plurality of resonance frequencies, which allows a plurality of working frequencies to lie next to each other and makes it possible to expand the working frequency band in the antenna. The antenna can transmit or receive radio waves in all the bands of the usable frequency band and can be used in a wide frequency band (a wide band). Since the antenna can arbitrarily set the size of the resonant conductor tube, the size covering the feeding section, and can arbitrarily set the size of the ground conductor tube, the size covering the passive section, it goes without saying that it is possible to change only the size of the resonant conductor tube, the size covering the feeding section, and change only the size of the ground conductor tube, the size covering the passive section, and it is possible to change both sizes. The antenna can move the working frequency band thereof to a higher or lower frequency band by changing at least one of the size of the resonant conductor tube, the size covering the feeding section, and the size of the ground conductor tube, the size covering the passive section, and can arbitrarily adjust the working frequency band to a higher or lower frequency band.

In the antenna in which the distance from the inner circumferential surface of the ground conductor tube to the outer circumferential surface of the passive section of the unbalanced feed member is in the range of 8 to 12 mm, by setting the distance in that range, the reflection efficiency (resonance efficiency) of radio waves between the passive section and the ground conductor tube covering the passive section is optimized, making it possible to resonate the passive section and the ground conductor tube efficiently. As a result of the feeding section and the resonant conductor tube resonating efficiently and the passive section and the ground conductor tube resonating efficiently, the antenna can obtain a plurality of resonance frequencies, which allows a plurality of working frequencies to lie next to each other and makes it possible to expand greatly the working frequency band in the antenna. The antenna can transmit or receive radio waves in all the bands of the usable frequency band and can be used in a wide frequency band (a wide band).

In the antenna in which the distance from the inner circumferential surface of the resonant conductor tube to the center of the feeding section of the unbalanced feed member is in the range of 4 to 10 mm, by setting the distance in that range, the reflection efficiency (resonance efficiency) of radio waves between the feeding section and the resonant conductor tube covering the feeding section is optimized, making it possible to resonate the feeding section and the resonant conductor tube efficiently. As a result of the feeding section and the resonant conductor tube resonating efficiently and the passive section and the ground conductor tube resonating efficiently, the antenna can obtain a plurality of resonance frequencies, which allows a plurality of working frequencies to lie next to each other and makes it possible to expand greatly the working frequency band in the antenna. The antenna can transmit or receive radio waves in all the bands of the usable frequency band and can be used in a wide frequency band (a wide band).

In the antenna in which the distance from the inner circumferential surface of the ground conductor tube to the outer circumferential surface of the passive section of the unbalanced feed member is greater than the distance from the inner circumferential surface of the resonant conductor tube to the outer circumferential surface of the feeding section of the unbalanced feed member, the reflection efficiency (resonance efficiency) of radio waves between the feeding section and the resonant conductor tube and the reflection efficiency (resonance efficiency) of radio waves between the passive section and the ground conductor tube are optimized, making it possible to resonate the feeding section and the resonant conductor tube efficiently and resonate the passive section and the ground conductor tube efficiently. As a result of the feeding section and the resonant conductor tube resonating efficiently and the passive section and the ground conductor tube resonating efficiently, the antenna can obtain a plurality of resonance frequencies, which allows a plurality of working frequencies to lie next to each other and makes it possible to expand greatly the working frequency band in the antenna. The antenna can transmit or receive radio waves in all the bands of the usable frequency band and can be used in a wide frequency band (a wide band).

In the antenna in which the feeding section of the unbalanced feed member is formed of the first conductor and the first insulator and the passive section of the unbalanced feed member is formed of at least the first and second conductors and the first insulator of the first and second conductors and the first and second insulators, the feeding section and the resonant conductor tube covering the feeding section resonate reliably, and the passive section and the ground conductor tube covering the passive section resonate reliably, making it possible to obtain a plurality of resonance frequencies, which allows a plurality of working frequencies to lie next to each other and makes it possible to expand the working frequency band in the antenna. The antenna can transmit or receive radio waves in all the bands of the usable frequency band and can be used in a wide frequency band (a wide band).

The antenna in which, in the feeding section of the unbalanced feed member, a predetermined length of the first conductor is exposed outward from the first insulator in the length direction thereof can move the resonance point of the feeding section and the resonant conductor tube to a higher point, making it possible to move the working frequency band of the antenna to a higher frequency band. The antenna can arbitrarily adjust the working frequency band to a higher or lower frequency band by changing the length of the exposed portion of the first conductor in the feeding section. In the antenna, the feeding section and the resonant conductor tube covering the feeding section resonate reliably, and the passive section and the ground conductor tube covering the passive section resonate reliably, making it possible to obtain a plurality of resonance frequencies, which allows a plurality of working frequencies to lie next to each other and makes it possible to expand the working frequency band in the antenna and transmit or receive radio waves in all the bands of the usable frequency band.

The antenna in which, to the first conductor exposed from the first insulator, a third insulator having a predetermined length is electrically fixed can optimize VSWR (voltage standing wave ratio) at a high frequency within the working frequency band and move the resonance point of the feeding section and the resonant conductor tube to a higher point, making it possible to move the working frequency band of the antenna to a higher frequency band. The antenna can arbitrarily adjust the working frequency band to a higher or lower frequency band by changing the length of the third conductor which is fixed to the first conductor. In the antenna, the feeding section and the resonant conductor tube covering the feeding section resonate reliably, and the passive section and the ground conductor tube covering the passive section resonate reliably, making it possible to obtain a plurality of resonance frequencies, which allows a plurality of working frequencies to lie next to each other and makes it possible to expand the working frequency band in the antenna and transmit or receive radio waves in all the bands of the usable frequency band.

The antenna in which, to the first conductor exposed from the first insulator, a third insulator having a predetermined length is fixed can optimize VSWR (voltage standing wave ratio) at a low frequency within the working frequency band and increase the resonance wavelength of the in-tube resonance of the feeding section and the resonant conductor tube, making it possible to move the working frequency band to a lower frequency band. The antenna can arbitrarily adjust the working frequency band to a higher or lower frequency band by changing the length of the third insulator which is fixed to the first conductor. In the antenna, the feeding section and the resonant conductor tube covering the feeding section resonate reliably, and the passive section and the ground conductor tube covering the passive section resonate reliably, making it possible to obtain a plurality of resonance frequencies, which allows a plurality of working frequencies to lie next to each other and makes it possible to expand the working frequency band in the antenna and transmit or receive radio waves in all the bands of the usable frequency band.

In the antenna in which the resonant conductor tube, the ground conductor tube, and the exposed portion of the feeding section are covered with a cover member having a predetermined permittivity, the working frequency band in the antenna expands to a lower frequency band by the permittivity of the cover member, making it possible to expand further the working frequency band in the antenna as compared to a case in which the cover member is not used. The antenna can transmit or receive radio waves in all the bands of the usable frequency band and can be used in a wide frequency band (a wide band).

In the antenna in which the cover member is made of thermoplastic synthetic resin, the thermoplastic synthetic resin has a predetermined permittivity, and the working frequency band in the antenna expands to a lower frequency band by the permittivity, making it possible to expand further the working frequency band in the antenna as compared to a case in which the cover member is not used. The antenna can transmit or receive radio waves in all the bands of the usable frequency band and can be used in a wide frequency band (a wide band).

### BRIEF DESCRIPTION OF DRAWINGS

FIG. 1 is a perspective view of an antenna shown as an example;

FIG. 2 is a sectional view taken on the line 2-2 of FIG. 1;

FIG. 3 is a diagram showing an example of a fixing unit;

FIG. 4 is a diagram showing another example of the fixing unit;

FIG. 5 is a diagram showing the correlation between a distance and a working frequency band;

FIG. 6 is a perspective view of an antenna shown as another example;

FIG. 7 is a sectional view taken on the line 7-7 of FIG. 6;

FIG. 8 is a perspective view of an antenna shown as another example;

FIG. 9 is a sectional view taken on the line 9-9 of FIG. 8;

FIG. 10 is a perspective view of a feeding section shown as an example;

FIG. 11 is a perspective view of a feeding section shown as another example;

FIG. 12 is a perspective view of a feeding section shown as another example;

FIG. 13 is a diagram showing the correlation between VSWR (voltage standing wave ratio) and a use band;

FIG. 14 is a diagram showing the radio field intensity measured in a circumferential direction of the antenna;

FIG. 15 is a diagram showing the radio field intensity measured in a circumferential direction of the antenna;

FIG. 16 is a perspective view of an antenna with a cover shown as an example;

FIG. 17 is a perspective view of a cover member shown as an example;

FIG. 18 is a perspective view of the antenna with a cover shown in a state in which the antenna is installed in the cover member; and

FIG. 19 is a diagram showing the correlation between the VSWR (voltage standing wave ratio) and a use band of the antenna with a cover.

### BEST MODES FOR CARRYING OUT THE INVENTION

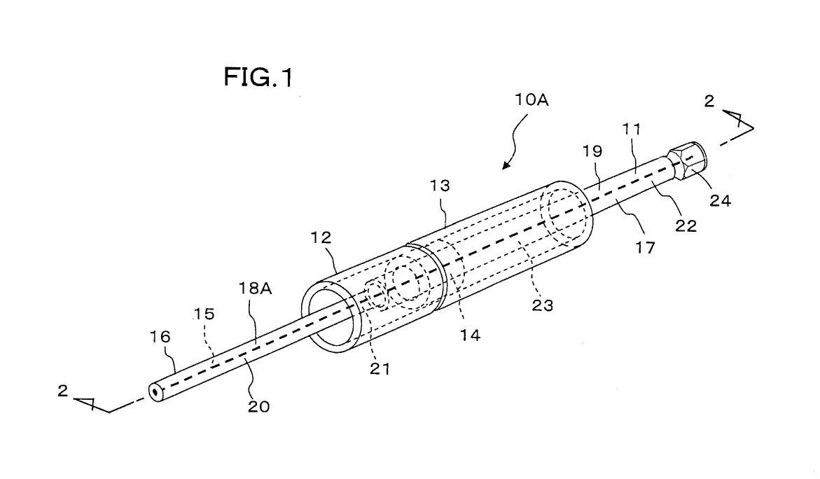

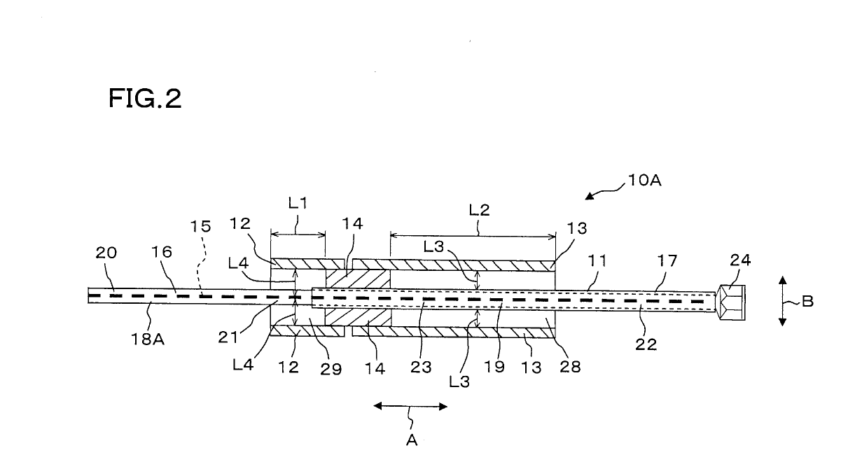

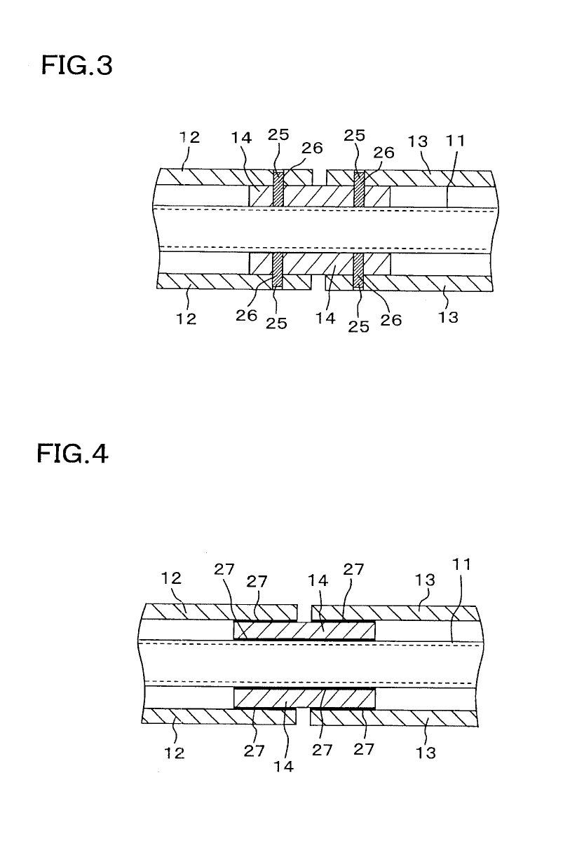

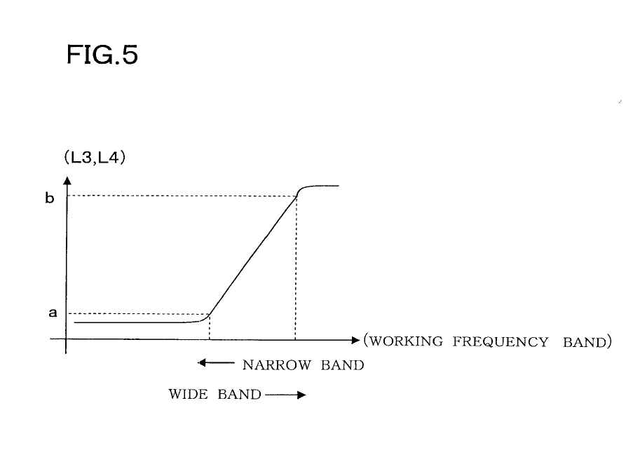

The details of an antenna (a sleeve antenna) according to the present invention will be described below with reference to the accompanying drawings, such as FIG. 1, showing an example of the antenna. Incidentally, FIG. 2 is a sectional view taken on the line 2-2 of FIG. 1, the line indicated with arrows, and FIG. 3 is a diagram showing an example of a fixing unit. FIG. 4 is a diagram showing another example of the fixing unit, and FIG. 5 is a diagram showing the correlation between distances L3 and L4 and a working frequency band. In FIG. 2, a length direction is indicated with an arrow A, and a radial direction is indicated with an arrow B. In FIGS. 1 and 2, the fixing unit is not shown. In FIG. 2, an unbalanced feed member 11 is shown in an uncut state.

An antenna 10A is formed of the unbalanced feed member (a coaxial cable or a semirigid cable) extending in a length direction, a resonant conductor tube 12 (a sleeve) and a ground conductor tube 13 (a sleeve), and a connection conductor guide 14 (a connection conductor tube). The resonant conductor tube 12 and the ground conductor tube 13 are disposed on the outside of the outer circumferential surface of the unbalanced feed member 11 and extend in a length direction.

The unbalanced feed member 11 is made of a first conductor 15 (a central metal conductor), a first insulator 16 covering the outer circumferential surface of the first conductor 15, and a second conductor 17 (an outer metal conductor) covering the outer circumferential surface of the first insulator 16. In the unbalanced feed member 11, the outer circumferential surface of the first conductor 15 and the inner circumferential surface of the first insulator 16 are firmly fixed to each other, and the outer circumferential surface of the first insulator 16 and the inner circumferential surface of the second conductor 17 are firmly fixed to each other. The unbalanced feed member 11 has a feeding section 18A set at a length of about V4 and a passive section 19 leading to the feeding section 18A and having a predetermined length. The feeding section 18A is formed of the first conductor 15 and the first insulator 16, and the passive section 19 is formed of the first conductor 15, the first insulator 16, and the second conductor 17.

Incidentally, in addition to the first conductor 15, the first insulator 16, and the second conductor 17, the unbalanced feed member 11 may include a second insulator (not shown) covering the outer circumferential surface of the second conductor 17. In this case, the outer circumferential surface of the second conductor 17 and the inner circumferential surface of the second insulator are firmly fixed to each other, and the passive section 19 is formed of the first conductor 15, the first insulator 16, the second conductor 17, and the second insulator. Conductive metal such as aluminum or copper can be used for the first and second conductors 15 and 17, and thermoplastic synthetic resin (in particular, fluorocarbon resin having the permittivity of plastic) can be used for the first and second insulators 16.

The resonant conductor tube 12 is made of conductive metal (such as aluminum or copper) and is formed by molding to have a cylindrical shape. The resonant conductor tube 12 is located on the outside of the outer circumferential surface of the feeding section 18A of the unbalanced feed member 11 and covers the outer circumferential surface of the feeding section 18A. The feeding section 18A of the unbalanced feed member 11 is placed through the resonant conductor tube 12. The feeding section 18A is divided into an exposed portion 20 with a predetermined size, the exposed portion 20 exposed from the resonant conductor tube 12 outward in the length direction (forward in the length direction) of the conductor tube 12, and an unexposed portion 21 with a predetermined size, the unexposed portion 21 extending to the inside of the resonant conductor tube 12 and entirely covered with the conductor tube 12.

The ground conductor tube 13 is made of conductive metal (such as aluminum or copper) and is formed by molding to have a cylindrical shape. The ground conductor tube 13 is located on the outside of the outer circumferential surface of the passive section 19 of the unbalanced feed member 11 and covers the outer circumferential surface of the passive section 19. The passive section 19 is placed through the ground conductor tube 13. The passive section is divided into an exposed portion 22 with a predetermined size, the exposed portion 22 exposed from the ground conductor tube 13 outward in the length direction (rearward in the length direction) of the conductor tube 13, and an unexposed portion 23 with a predetermined size, the unexposed portion 23 extending to the inside of the ground conductor tube 13 and entirely covered with the conductor tube 13. To a back end of the exposed portion 22 exposed from the ground conductor tube 13, a connector 24 is attached.

The connection conductor guide 14 is made of conductive metal (such as aluminum or copper) and is formed by molding to have a cylindrical shape. The connection conductor guide 14 lies between the unbalanced feed member 11 and the resonant conductor tube 12 and also lies between the unbalanced feed member 11 and the ground conductor tube 13. The inner circumferential surface of the connection conductor guide 14 is electrically fixed to the outer circumferential surface of the unbalanced feed member 11 (the outer circumferential surface of the second conductor 17) via the fixing unit, the outer circumferential surface thereof is electrically fixed to the inner circumferential, surface of the resonant conductor tube 11 via the fixing unit, and the outer circumferential surface thereof is electrically fixed to the inner circumferential surface of the ground conductor tube 13 via the fixing unit.

As an example of the fixing unit, as shown in FIG. 3, a screw 25 can be used. In the resonant conductor tube 12, the ground conductor tube 13, and the connection conductor guide 14, screw holes 26 penetrating them in the radial direction thereof are formed. In each screw hole 26, a screw groove (not shown) into which the screw thread of the screw 25 is fitted is formed. When the screws 25 are screwed into the screw holes 26, the screw threads of the screws 25 are fitted into the screw grooves of the screw holes 26, and, at the same time, the screws 25 gradually enter the screw holes 26 of the conductor tubes 12 and 13 and the guide 14. When the screws 25 enter the screw holes 26, the conductor tubes 12 and 13 and the guide 14 are connected with the screws 25, the screws 25 presses the guide 14 against the outer circumferential surface of the unbalanced feed member 11 (the outer circumferential surface of the second conductor 17), the guide 14 and the unbalanced feed member 11 are fixed, and the conductor tubes 12 and 13 and the guide 14 are fixed. When they are fixed with the screws 25, the unbalanced feed member 11 and the conductor tubes 12 and 13 are brought into conduction via the guide 14.

As another example of the fixing unit, as shown in FIG. 4, a conductive adhesive 27 containing a conductive filler such as silver powder or copper powder or carbon fiber can be used. The inner circumferential surface of the connection conductor guide 14 and the outer circumferential surface of the unbalanced feed member 11 (the outer circumferential surface of the second conductor 17) are fixed with the conductive adhesive 27, the outer circumferential surface of the guide 14 and the inner circumferential surface of the resonant conductor tube 12 are fixed with the conductive adhesive 27, and the outer circumferential surface of the guide 14 and the inner circumferential surface of the ground conductor tube 13 are fixed with the conductive adhesive 27. When they are fixed with the adhesive 27, the unbalanced feed member 11 and the conductor tubes 12 and 13 are brought into conduction via the guide 14.

The antenna 10A allows the size L1 of the resonant conductor tube 12, the size L1 covering the feeding section 18A, and the size L2 of the ground conductor tube 13, the size L2 covering the passive section 19, to be arbitrarily set. In the antenna 10A, it goes without saying that it is possible to change only the size L1 of the resonant conductor tube 12, the size L1 covering the feeding section 18A, and change only the size L2 of the ground conductor tube 13, the size L2 covering the passive section 19, and it is possible to change both of the sizes L1 and L2.

To change the size L1 of the resonant conductor tube 12, the size L1 covering the feeding section 18A, the length of the resonant conductor tube 12 is changed, a position in which the resonant conductor tube 12 is fixed to the guide 14 is moved forward or rearward in a length direction, or the length of the resonant conductor tube 12 is changed and a position in which the resonant conductor tube 12 is fixed to the guide 14 is moved forward or rearward in a length direction. To change the size L2 of the ground conductor tube 13, the size L2 covering the passive section 19, the length of the ground conductor tube is changed, a position in which the ground conductor tube 13 is fixed to the guide 14 is moved forward or rearward in a length direction, or the length of the ground conductor tube 13 is changed and a position in which the ground conductor tube 13 is fixed to the guide 14 is moved forward or rearward in a length direction.

In the antenna 10A, between the inner circumferential surface of the ground conductor tube 13 and the outer circumferential surface of the passive section 19 of the unbalanced feed member 11 (the outer circumferential surface of the second conductor 17), predetermined space 28 is formed, and, between the inner circumferential surface of the resonant conductor tube 12 and the outer circumferential surface of the feeding section 18A of the unbalanced feed member 11 (the outer circumferential surface of the first insulator 16), predetermined space 29 is formed. The distance L3 from the inner circumferential surface of the ground conductor tube 13 to the outer circumferential surface of the passive section 19 of the unbalanced feed member 11 (the outer circumferential surface of the second conductor 17) is in the range of 8 to 12 mm, and is most preferably 10 mm. In the antenna 10A, the distance L4 from the inner circumferential surface of the resonant conductor tube 12 to the center of the feeding section 18A of the unbalanced feed member 11 (the center of the first conductor 15) is almost the same as the distance L3.

By setting the distance L3 in the range of 8 to 12 mm, preferably at 10 mm, the reflection efficiency (resonance efficiency) of radio waves between the ground conductor tube 13 and the passive section 19 is optimized, allowing the antenna 10A to resonate the ground conductor tube 13 and the passive section 19 efficiently. Moreover, the reflection efficiency (resonance efficiency) of radio waves between the resonant conductor tube 12 and the feeding section 18A is improved, making it possible to resonate the resonant conductor tube 12 and the feeding section 18A efficiently. Incidentally, when the passive section 19 of the unbalanced feed member 11 is formed of the first and second conductors 15 and 17 and the first and second insulators 16, the distance L3 is the size from the inner circumferential surface of the ground conductor tube 13 to the outer circumferential surface of the second conductor 17.

When the distance L3 is less than 8 mm, resonance of the ground conductor tube 13 and the passive section 19 of the unbalanced feed member 11 becomes insufficient and resonance of the resonant conductor tube 12 and the feeding section 18A of the unbalanced feed member 11 becomes insufficient, making it impossible to obtain a plurality of resonance frequencies and expand the frequency band in the antenna 10A. When the distance L3 exceeds 12 mm, the frequency band in the antenna 10A is saturated in a state in which the frequency band is the widest, making it impossible to expand the frequency band of the antenna 10A any more. Furthermore, when the distance L3 is increased too much, it is sometimes impossible to resonate the ground conductor tube 13 and the passive section 19 of the unbalanced feed member 11 and produce in-tube resonance of the resonant conductor tube 12 and the feeding section 18A of the unbalanced feed member 11.

In the antenna 10A, as shown in FIG. 5, as the distance L3 becomes greater than about 0.2 mm (point a), the working frequency band expands steeply, and the working frequency band becomes the widest when the distance L3 is about 10 mm (point b). The working frequency band of the antenna 10A becomes almost constant even when the distance L3 becomes greater than about 10 mm. Moreover, as the distance L4 becomes greater than about 0.2 mm (point a), the working frequency band expands steeply, and the working frequency band becomes the widest when the distance L4 is about 6 mm (point b). The working frequency band of the antenna 10A becomes almost constant even when the distance L4 becomes greater than about 6 mm.

In the antenna 10A, the distances L3 and L4 are in the range of 8 to 12 mm, and in-tube resonance is reliably produced in the feeding section 18A and the resonant conductor tube 12 covering the feeding section 18A and resonance is reliably produced in the passive section 19 and the ground conductor tube 13 covering the passive section 19, making it possible to obtain a plurality of resonance frequencies, which allows a plurality of working frequencies to lie next to each other and makes it possible to expand the working frequency band in the antenna 10A. The antenna 10A can transmit or receive radio waves in all the bands of the usable frequency band and can be used in a wide frequency band (a wide band). The antenna 10A can arbitrarily move the working frequency band thereof to a higher or lower frequency band by changing at least one of the sizes L1 and L2, the size L1 of the resonant conductor tube 12, the size L1 covering the feeding section 18A, and the size L2 of the ground conductor tube 13, the size L2 covering the passive section 19.

For example, when the size L1 of the resonant conductor tube 12, the size L1 covering the feeding section 18A, is made longer than the size shown in the drawing, the resonance point of the feeding section 18A and the resonant conductor tube 12 moves to a higher point, making it possible to move the working frequency band of the antenna 10A to a higher frequency band. On the other hand, when the size L1 of the resonant conductor tube 12, the size L1 covering the feeding section 18A, is made shorter than the size shown in the drawing, the wavelength of the in-tube resonance of the feeding section 18A and the resonant conductor tube 12 is increased, making it possible to move the working frequency band of the antenna 10A to a lower frequency band. Moreover, when the size L2 of the ground conductor tube 13, the size L2 covering the passive section 19, is made longer than the size shown in the drawing, the resonance wavelength of the passive section 19 and the ground conductor tube 13 is increased, making it possible to move the working frequency band of the antenna 10A to a lower frequency band. On the other hand, when the size L2 of the ground conductor tube 13, the size L2 covering the passive section 19, is made shorter than the size shown in the drawing, the resonance point of the passive section 19 and the ground conductor tube 13 moves to a higher point, making it possible to move the working frequency band of the antenna 10A to a higher frequency band.

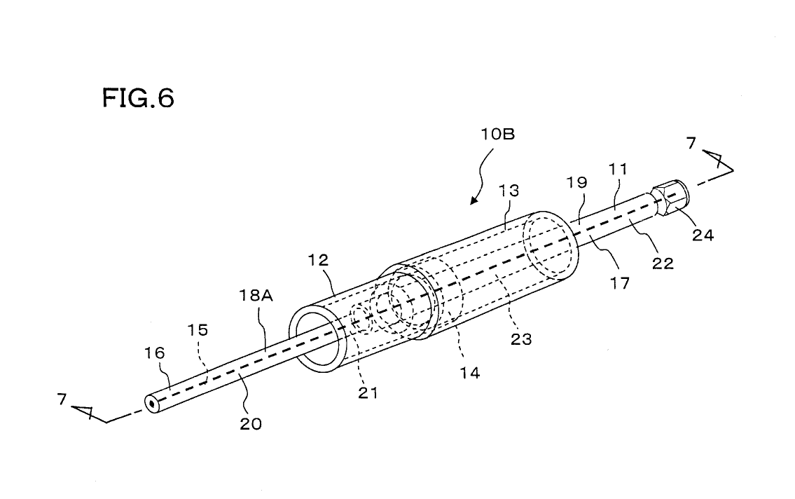

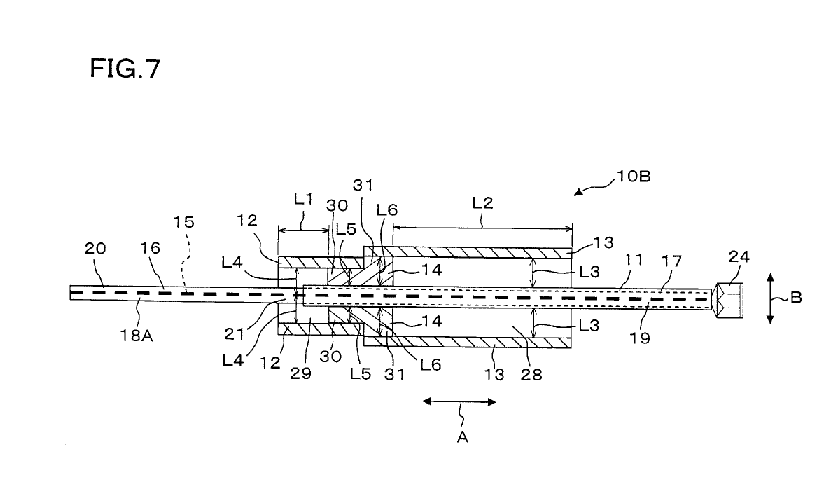

FIG. 6 is a perspective view of an antenna 10B shown as another example, and FIG. 7 is a sectional view taken on the line 7-7 of FIG. 6, the line indicated with arrows. In FIG. 7, a length direction is indicated with an arrow A, and a radial direction is indicated with an arrow B. In FIGS. 6 and 7, a fixing unit is not shown. In FIG. 7, an unbalanced feed member 11 is shown in an uncut state. The antenna 10B is formed of the unbalanced feed member 11 (a coaxial cable or a semirigid cable) extending in a length direction, a resonant conductor tube 12 (a sleeve) and a ground conductor tube 13 (a sleeve), and a connection conductor guide 14 (a connection conductor tube). The antenna 10B differs from the antenna of FIG. 1 in that a step is formed in the radial thickness of the connection conductor guide 14, and other structures are the same as those of the antenna 10A of FIG. 1. Therefore, the description of the antenna 10A of FIG. 1 is quoted and the same reference characters as those used in FIG. 1 are assigned, and the descriptions of other structures of the antenna 10B will be omitted.

In the antenna 10B, between the inner circumferential surface of the ground conductor tube 13 and the outer circumferential surface of the passive section 19 of the unbalanced feed member 11 (the outer circumferential surface of the second conductor 17), predetermined space 28 is formed, and, between the inner circumferential surface of the resonant conductor tube 12 and the outer circumferential surface of the feeding section 18A of the unbalanced feed member 11 (the outer circumferential surface of the first insulator 16), predetermined space 29 is formed. In the connection conductor guide 14, the radial thickness L5 of a front part 30 to which the resonant conductor tube 12 is fixed is smaller than the radial thickness L6 of a rear part 31 to which the ground conductor tube 13 is fixed. Therefore, in the antenna 10B, the distance L3 from the inner circumferential surface of the ground conductor tube 13 to the outer circumferential surface of the passive section 19 of the unbalanced feed member 11 (the outer circumferential surface of the second conductor 17) is greater than the distance L4 from the inner circumferential surface of the resonant conductor tube 12 to the center of the feeding section 18A of the unbalanced feed member 11 (the center of the first conductor 15).

When the resonant conductor tube 12 is fixed to the guide 14 or the ground conductor tube 13 is fixed to the guide 14, the fixing unit of FIG. 3 using the screw 25 or the fixing unit of FIG. 4 using the conductive adhesive 27 is used. The distance L3 from the inner circumferential surface of the ground conductor tube 13 to the outer circumferential surface of the passive section 19 of the unbalanced feed member 11 (the outer circumferential surface of the second conductor 17) is in the range of 8 to 12 mm, and is most preferably 10 mm. The distance L4 from the inner circumferential surface of the resonant conductor tube 12 to the center of the feeding section 18A of the unbalanced feed member 11 (the center of the first conductor 15) is in the range of 4 to 10 mm, and is most preferably 6 mm.

By setting the distance L3 in the range of 8 to 12 mm, preferably at 10 mm, the reflection efficiency (resonance efficiency) of radio waves between the passive section 19 and the ground conductor tube 13 is optimized, allowing the antenna 10B to resonate the passive section 19 and the ground conductor tube 13 efficiently. Moreover, by setting the distance L4 in the range of 4 to 10 mm, preferably at 6 mm, the reflection efficiency (resonance efficiency) of radio waves between the feeding section 18 and the resonant conductor tube 12 is optimized, making it possible to resonate the feeding section 18 and the resonant conductor tube 12 efficiently. Incidentally, when the passive section 19 of the unbalanced feed member 11 is formed of the first and second conductors 15 and 17 and the first and second insulators 16, the distance L3 is the size from the inner circumferential surface of the ground conductor tube 13 to the outer circumferential surface of the second conductor 17.

The reason why the distance L3 is set in the above range is the same as the reason given for the antenna 10A of FIG. 1. When the distance L4 is less than 6 mm, resonance of the resonant conductor tube 12 and the feeding section 18A of the unbalanced feed member 11 becomes insufficient, making it impossible to generate a plurality of resonance frequencies and expand the frequency band in the antenna 10B. When the distance L4 exceeds 10 mm, the frequency band in the antenna 10B is saturated in a state in which the frequency band is the widest, making it impossible to expand the frequency band in the antenna 10B any more. Furthermore, when the distance L4 is increased too much, it is sometimes impossible to resonate the resonant conductor tube 12 and the feeding section 18A of the unbalanced feed member 11. Incidentally, by quoting FIG. 5, the description of the correlation between the distances L3 and L4 and the working frequency band is omitted.

As is the case with the antenna 10A of FIG. 1, the antenna 10B allows the size L1 of the resonant conductor tube 12, the size L1 covering the feeding section 18A, and the size L2 of the ground conductor tube 13, the size L2 covering the passive section 19, to be arbitrarily set. In the antenna 10B, it goes without saying that it is possible to change only the size L1 of the resonant conductor tube 12, the size L1 covering the feeding section 18A, and change only the size L2 of the ground conductor tube 13, the size L2 covering the passive section 19, and it is possible to change both of the sizes L1 and L2. The antenna 10B can arbitrarily move the working frequency band thereof to a higher or lower frequency band by changing at least one of the sizes L1 and L2, the size L1 of the resonant conductor tube 12, the size L1 covering the feeding section 18A, and the size L2 of the ground conductor tube 13, the size L2 covering the passive section 19.

In addition to the advantages of the antenna of FIG. 1, the antenna 10B has the following advantages. In the antenna 10B, by making the distance L3 from the inner circumferential surface of the ground conductor tube 13 to the outer circumferential surface of the passive section 19 of the unbalanced feed member 11 greater than the distance L4 from the inner circumferential surface of the resonant conductor tube 12 to the center of the feeding section 18A of the unbalanced feed member 11 (the center of the first conductor 15), the reflection efficiency (resonance efficiency) of radio waves between the feeding section 18A and the resonant conductor tube 12 and the reflection efficiency (resonance efficiency) of radio waves between the passive section 19 and the ground conductor tube 13 are optimized, making it possible to resonate the feeding section 18A and the resonant conductor tube 12 efficiently and resonate the passive section 19 and the ground conductor tube 13 efficiently.

In the antenna 10B, the distance L3 is in the range of 8 to 12 mm and preferably 10 mm and the distance L4 is in the range of 4 to 10 mm and preferably 6 mm, and the feeding section 18A and the resonant conductor tube 12 covering the feeding section 18A resonate reliably and the passive section 19 and the ground conductor tube 13 covering the passive section 19 resonate reliably, making it possible to obtain a plurality of resonance frequencies, which allows a plurality of working frequencies to lie next to each other and makes it possible to expand greatly the working frequency band in the antenna 10B and transmit or receive radio waves in all the bands of the usable frequency band.

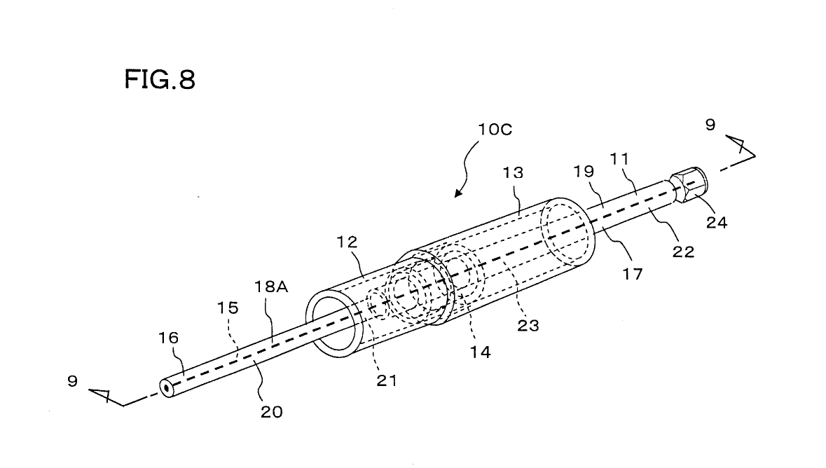

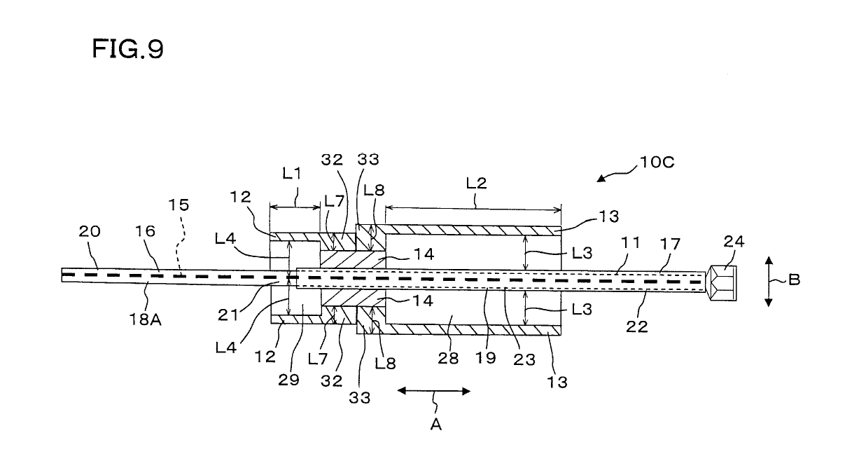

FIG. 8 is a perspective view of an antenna 10C shown as another example, and FIG. 9 is a sectional view taken on the line 9-9 of FIG. 8, the line indicated with arrows. In FIG. 9, a length direction is indicated with an arrow A, and a radial direction is indicated with an arrow B. In FIGS. 8 and 9, a fixing unit is not shown. In FIG. 9, an unbalanced feed member 11 is shown in an uncut state. The antenna 10C is formed of the unbalanced feed member 11 (a coaxial cable or a semirigid cable) extending in a length direction, a resonant conductor tube 12 (a sleeve) and a ground conductor tube 13 (a sleeve), and a connection conductor guide 14 (a connection conductor tube). The antenna 10C differs from the antenna of FIG. 1 in that the radial thickness L7 of a part 32 of the resonant conductor tube 12, the part 32 fixed to the guide 14, is smaller than the radial thickness L8 of a part 33 of the ground conductor tube 13, the part 33 fixed to the guide 14, and other structures are the same as those of the antenna 10A of FIG. 1. Therefore, the description of the antenna 10A of FIG. 1 is quoted and the same reference characters as those used in FIG. 1 are assigned, and the descriptions of other structures of the antenna 10C will be omitted.

In the antenna 10C, between the inner circumferential surface of the ground conductor tube 13 and the outer circumferential surface of the passive section 19 of the unbalanced feed member 11 (the outer circumferential surface of the second conductor 17), predetermined space 28 is formed, and, between the inner circumferential surface of the resonant conductor tube 12 and the outer circumferential surface of the feeding section 18A of the unbalanced feed member 11 (the outer circumferential surface of the first insulator 16), predetermined space 29 is formed. The radial thickness L7 of the part 32 of the resonant conductor tube 12, the part 32 fixed to the guide 14, is smaller than the radial thickness L8 of the part 33 of the ground conductor tube 13, the part 33 fixed to the guide 14. Therefore, in the antenna 10C, the distance L3 from the inner circumferential surface of the ground conductor tube 13 to the outer circumferential surface of the passive section 19 of the unbalanced feed member 11 (the outer circumferential surface of the second conductor 17) is greater than the distance L4 from the inner circumferential surface of the resonant conductor tube 12 to the center of the feeding section 18A of the unbalanced feed member 11 (the center of the first conductor 15).

When the resonant conductor tube 12 is fixed to the guide 14 or the ground conductor tube 13 is fixed to the guide 14, the fixing unit of FIG. 3 using the screw 25 or the fixing unit of FIG. 4 using the conductive adhesive 27 is used. The distance L3 from the inner circumferential surface of the ground conductor tube 13 to the outer circumferential surface of the passive section 19 of the unbalanced feed member 11 (the outer circumferential surface of the second conductor 17) is in the range of 8 to 12 mm, and is most preferably 10 mm. The distance L4 from the inner circumferential surface of the resonant conductor tube 12 to the center of the feeding section 18A of the unbalanced feed member 11 (the center of the first conductor 15) is in the range of 4 to 10 mm, and is most preferably 6 mm.

By setting the distance L3 in the range of 8 to 12 mm, preferably at 10 mm, the reflection efficiency (resonance efficiency) of radio waves between the passive section 19 and the ground conductor tube 13 is optimized, allowing the antenna 10C to resonate the passive section 19 and the ground conductor tube 13 efficiently. Moreover, by setting the distance L4 in the range of 4 to 10 mm, preferably at 6 mm, the reflection efficiency (resonance efficiency) of radio waves between the feeding section 18A and the resonant conductor tube 12 is optimized, making it possible to resonate the feeding section 18A and the resonant conductor tube 12 efficiently. The reason why the distances L3 and L4 are set in the above ranges is the same as the reason given for the antennas 10A and 10B of FIGS. 1 and 6. Incidentally, by quoting FIG. 5, the description of the correlation between the distances L3 and L4 and the working frequency band is omitted.

As is the case with the antenna 10A of FIG. 1, the antenna 10C allows the size L1 of the resonant conductor tube 12, the size L1 covering the feeding section 18A, and the size L2 of the ground conductor tube 13, the size L2 covering the passive section 19, to be arbitrarily set. In the antenna 10C, it goes without saying that it is possible to change only the size L1 of the resonant conductor tube 12, the size L1 covering the feeding section 18A, and change only the size L2 of the ground conductor tube 13, the size L2 covering the passive section 19, and it is possible to change both of the sizes L1 and L2. The antenna 10C can arbitrarily move the working frequency band thereof to a higher or lower frequency band by changing at least one of the sizes L1 and L2, the size L1 of the resonant conductor tube 12, the size L1 covering the feeding section 18A, and the size L2 of the ground conductor tube 13, the size L2 covering the passive section 19.

In addition to the advantages of the antenna of FIG. 1, the antenna 10C has the following advantages. In the antenna 10C, by making the distance L3 from the inner circumferential surface of the ground conductor tube 13 to the outer circumferential surface of the passive section 19 of the unbalanced feed member 11 greater than the distance L4 from the inner circumferential surface of the resonant conductor tube 12 to the center of the feeding section 18A of the unbalanced feed member 11, the reflection efficiency (resonance efficiency) of radio waves between the feeding section 18A and the resonant conductor tube 12 and the reflection efficiency (resonance efficiency) of radio waves between the passive section 19 and the ground conductor tube 13 are optimized, making it possible to resonate the feeding section 18A and the resonant conductor tube 12 efficiently and resonate the passive section 19 and the ground conductor tube 13 efficiently.

In the antenna 10C, the distance L3 is in the range of 8 to 12 mm and preferably 10 mm and the distance L4 is in the range of 4 to 10 mm and preferably 6 mm, and the feeding section 18A and the resonant conductor tube 12 covering the feeding section 18A resonate reliably and the passive section 19 and the ground conductor tube 13 covering the passive section 19 resonate reliably, making it possible to obtain a plurality of resonance frequencies, which allows a plurality of working frequencies to lie next to each other and makes it possible to expand greatly the working frequency band in the antenna 10C and transmit or receive radio waves in all the bands of the usable frequency band.

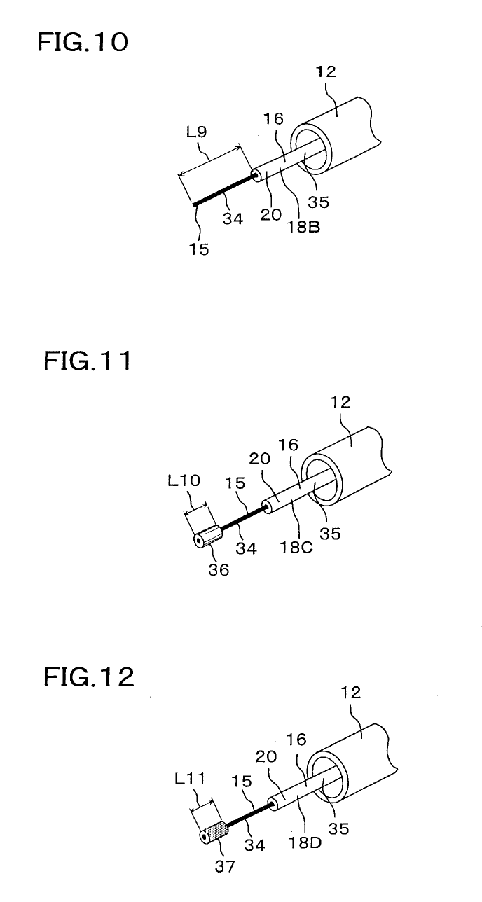

FIG. 10 is a perspective view of a feeding section 18B shown as an example. In FIG. 10, only part of the feeding section 18B and a resonant conductor tube 12 is shown, and other parts are not shown. An exposed portion 20 of the feeding section 18B, the exposed portion 20 exposed outward (forward) from the resonant conductor tube 12 in a length direction, has a front part 34 formed only of a first conductor 15 and a rear part 35 formed of the first conductor 15 and a first insulator 16. Therefore, in the feeding section 18B, a predetermined length of the first conductor 15 is exposed outward from the first insulator 16 in the length direction thereof. Incidentally, as other structures of an antenna having the feeding section 18B, the structures of any of the antennas 10A, 10B, and 10C of FIGS. 1, 6, and 8 can be used.

In the antennas 10A, 10B, and 10C having the feeding section 18B of FIG. 10, as compared to a case in which the whole of the feeding section 18A is formed of the first conductor 15 and the first insulator 16, the resonance point of the feeding section 18B and the resonant conductor tube 12 moves to a higher point. Incidentally, when the length L9 of the exposed portion of the first conductor 15 in the feeding section 18B is increased, it is possible to promote the movement of the resonance point to a higher point; when the length L9 of the exposed portion of the first conductor 15 in the feeding section 18B is reduced, it is possible to suppress the movement of the resonance point to a higher point.

In addition to the advantages of the antennas 10A, 10B, and 10C of FIGS. 1, 6, and 8, the antennas 10A, 10B, and 10C having the feeding section 18B have the following advantages. The antennas 10A, 10B, and 10C can move the resonance point to a higher point by exposing a predetermined length of the first conductor 15 in the feeding section 18B, making it possible to move the working frequency bands of the antennas 10A, 10B, and 10C to a higher frequency band. The antennas 10A, 10B, and 10C can arbitrarily adjust the working frequency band to a higher or lower frequency band by changing the length L9 of the exposed portion of the first conductor 15 in the feeding section 18B.

FIG. 11 is a perspective view of a feeding section 18C shown as another example. In FIG. 11, only part of the feeding section 18C and a resonant conductor tube 12 is shown, and other parts are not shown. An exposed portion 20 of the feeding section 18C, the exposed portion 20 exposed outward (forward) from the resonant conductor tube 12 in a length direction, has a front part 34 formed only of a first conductor 15 and a rear part 35 formed of the first conductor 15 and a first insulator 16. Therefore, in the feeding section 18C, a predetermined length of the first conductor 15 is exposed outward from the first insulator 16 in the length direction thereof. To the front part 34 (the first conductor 15 exposed from the first insulator 16), a third metal conductor tube 36 (a third conductor) having a predetermined length is electrically fixed. The third metal conductor tube 36 is made of aluminum, copper, or the like. Incidentally, as other structures of an antenna having the feeding section 18C, the structures of any of the antennas 10A, 10B, and 10C of FIGS. 1, 6, and 8 can be used.

In the antennas 10A, 10B, and 10C having the feeding section 18C of FIG. 11, as compared to a case in which the exposed portion 20 is formed of the first conductor 15 and the first insulator 16 and a case in which the exposed portion 20 is formed only of the first conductor 15, the in-tube resonance point of the feeding section 18C and the resonant conductor tube 12 moves to a higher point. Incidentally, by increasing the length L10 of the third metal conductor tube 36 fixed to the front part 34 (the first conductor 15), it is possible to optimize the VSWR of a higher frequency portion in the use band.

In addition to the advantages of the antennas 10A, 10B, and 10C of FIGS. 1, 6, and 8, the antennas 10A, 10B, and 10C having the feeding section 18C have the following advantages. The antennas 10A, 10B, and 10C can move the resonance point of the feeding section 18C and the resonant conductor tube 12 to a higher point by exposing the first conductor 15 in the feeding section 18C and fixing the third metal conductor tube 36 (the third conductor) to the front part 34 in which the first conductor 15 is exposed, making it possible to move the working frequency bands of the antennas 10A, 10B, and 10C to a higher frequency band and optimize the VSWR of a higher frequency portion in the use band. The antennas 10A, 10B, and 10C can arbitrarily adjust the VSWR of the working frequency band by changing the length L10 of the third metal conductor tube 36 which is fixed to the front part 34 (the first conductor 15).

FIG. 12 is a perspective view of a feeding section 18D shown as another example. In FIG. 12, only part of the feeding section 18D and a resonant conductor tube 12 is shown, and other parts are not shown. An exposed portion 20 of the feeding section 18D, the exposed portion 20 exposed outward (forward) from the resonant conductor tube 12 in a length direction, has a front part 34 formed only of a first conductor 15 and a rear part 35 formed of the first conductor 15 and a first insulator 16. Therefore, in the feeding section 18D, a predetermined length of the first conductor 15 is exposed outward from the first insulator 16 in the length direction thereof. To the front part 34 (the first conductor 15 exposed from the first insulator 16), a third insulator 37 having a predetermined length is fixed. Thermoplastic synthetic resin (in particular, fluorocarbon resin having the permittivity of plastic) can be used for the third insulator 37. Incidentally, as other structures of an antenna having the feeding section, the structures of any of the antennas 10A, 10B, and 10C of FIGS. 1, 6, and 8 can be used.

In the antennas 10A, 10B, and 10C having the feeding section 18D of FIG. 12, as compared to a case in which the exposed portion 20 is formed only of the first conductor 15, the wavelength of the in-tube resonance of the feeding section 18D and the resonant conductor tube 12 is increased. Incidentally, when the length L11 of the third insulator 37 which is fixed to the front part 34 (the first conductor 15) is increased, it is possible to increase further the length of the resonance wavelength; when the length L11 of the third insulator 37 which is fixed to the front part 34 (the first conductor 15) is reduced, it is possible to reduce the length of the resonance wavelength.

In addition to the advantages of the antennas 10A, 10B, and 10C of FIGS. 1, 6, and 8, the antennas 10A, 10B, and 10C having the feeding section 18D have the following advantages. The antennas 10A, 10B, and 10C can increase the wavelength of the in-tube resonance of the feeding section 18D and the resonant conductor tube 12 by exposing the first conductor 15 in the feeding section 18D and fixing the third conductor 37 to the front part 34 in which the first conductor 15 is exposed, making it possible to optimize the VSWR of a lower frequency portion in the working frequency band. The antennas 10A, 10B, and 10C can arbitrarily adjust the VSWR of the working frequency band by changing the length L11 of the third conductor 37 which is fixed to the front part 34 (the first conductor 15).

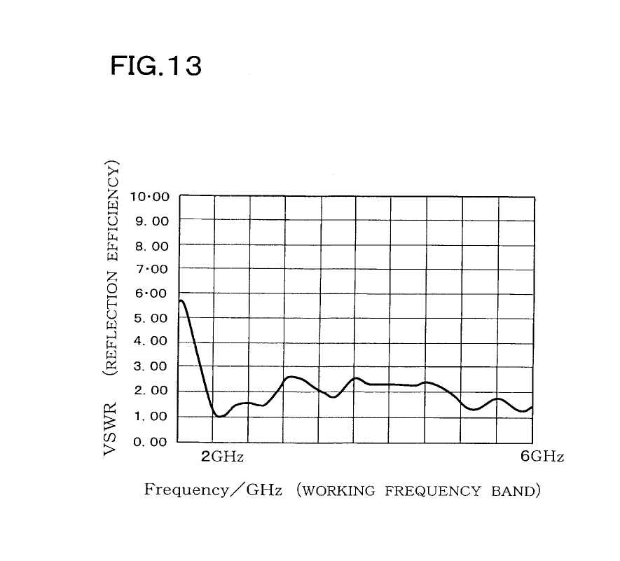

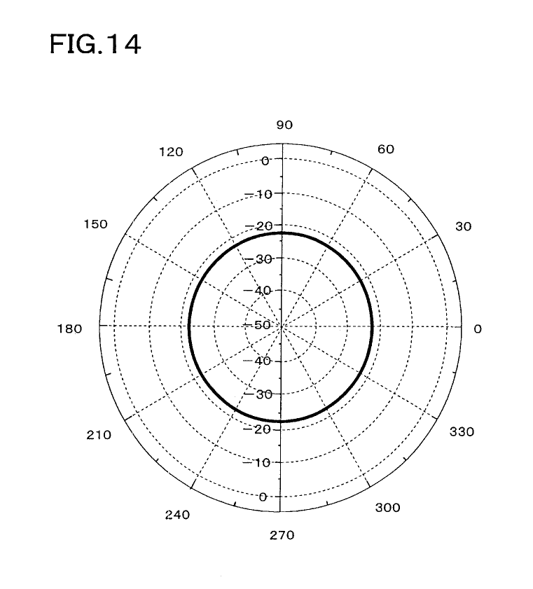

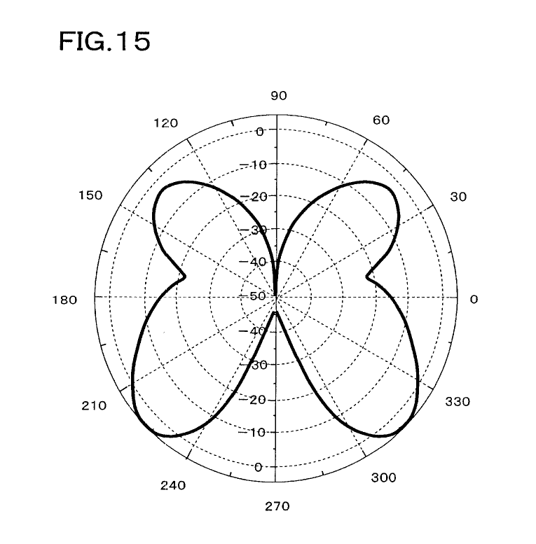

FIG. 13 is a diagram showing the correlation between VSWR (voltage standing wave ratio) and a use band, and FIGS. 14 and 15 are diagrams showing the radio field intensity measured in a circumferential direction in three planes (an X-Y plane, a Y-Z plane, and a Z-X plane) of the antennas 10A, 10B, and 10C. FIG. 14 shows the results of measurement of the radio field intensity of X-Y plane antenna characteristics in a circumferential direction (0° to 360°), and FIG. 15 shows the results of measurement of the radio field intensity of Y-Z plane or Z-X plane antenna characteristics in a circumferential direction (0° to 360°).

It is clear that, as shown in FIG. 13, the VSWR (voltage standing wave ratio) of each of the antennas 10A, 10B, and 10C shown in the drawings is 3 or less when the use frequencies thereof are from about 2.0 GHz to about 6.0 GHz, and the antennas 10A, 10B, and 10C have wide working frequency bands in a state in which high VSWR (voltage standing wave ratio) is maintained. Moreover, it is clear that, as shown in FIG. 14, the radio field intensity of X-Y plane antenna characteristics in a circumferential direction (0° to 360°) forms a virtually perfect circle and, as shown in FIG. 15, the radio field intensity of Y-Z plane or Z-X plane antenna characteristics in a circumferential direction (0° to 360°) forms the shape of a butterfly, and the antennas 10A, 10B, and 10C have good directionality.

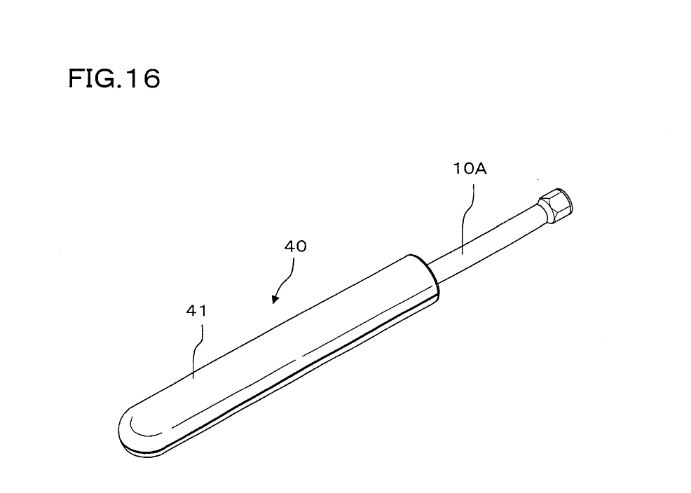

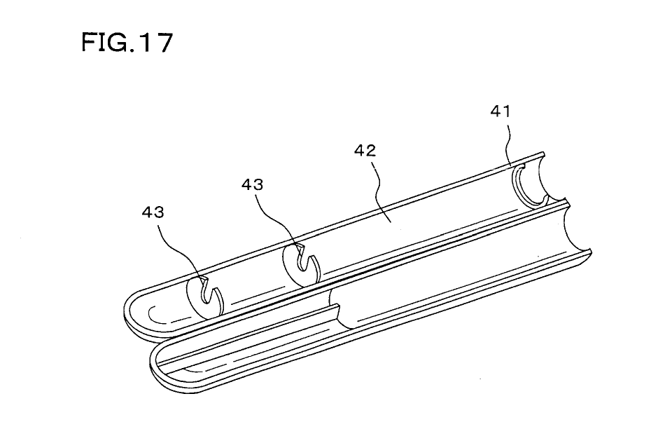

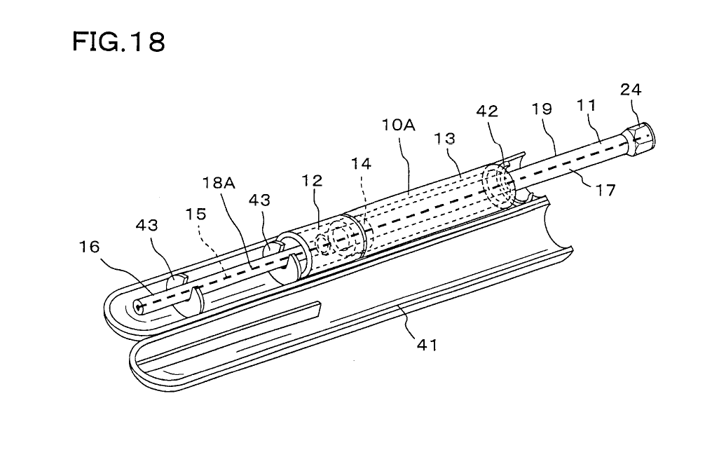

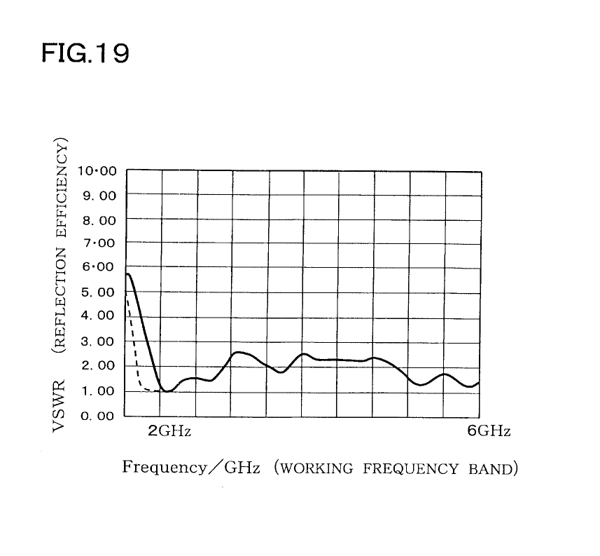

FIG. 16 is a perspective view of an antenna 40 with a cover shown as an example, and FIG. 17 is a perspective view of a cover member 41 shown as an example. FIG. 18 is a perspective view of the antenna 40 with a cover shown in a state in which the antenna 10A is installed in the cover member 41, and FIG. 19 is a diagram showing the correlation between the VSWR (voltage standing wave ratio) and a use band of the antenna 40 with a cover. The antenna 40 with a cover is formed of the antenna 10A and the cover member 41. The antenna 10A is the same as the antenna of FIG. 1, and therefore the description thereof will be omitted.

The cover member 41 is made of thermoplastic synthetic resin having a predetermined permittivity and is formed by molding to have the shape of a cylinder with a closed tip. As shown in FIG. 17, the cover member 41 is split into two parts (split into halves) in such a way that the circumference thereof is nearly halved. In the cover member 41, a first support section 42 supporting the resonant conductor tube 12 and the ground conductor tube 13 of the antenna 10A and a second support section 43 supporting the exposed portion 20 of the feeding section 18A of the antenna 10A are formed. The diameter of the first support section 42 is almost the same as the diameter of the resonant conductor tube 12 and the ground conductor tube 13 or is slightly greater than the diameter of these tubes 12 and 13. The cover member 41 has a length that allows the cover member 41 can cover the remainder of the antenna 10A except for part of the exposed portion 22 of the passive section 19 of the antenna 10A.

As shown in FIG. 18, when the antenna 10A is installed in the cover member 41, the resonant conductor tube 12 and the ground conductor tube 13 of the antenna 10A are fitted into the first support section 42 and the exposed portion 20 is fitted into the second support section 43. After the antenna 10A is installed in the cover member 41, when the halves of the cover member 41 are turned, the halves of the cover member 41 face each other and form the cylindrical cover member 41, and the entire area of the resonant conductor tube 12 of the antenna 10A, the entire area of the ground conductor tube 13, and the entire area of the exposed portion 20 of the feeding section 18A are covered with the cover member 41.

In the antenna 40 with a cover, the inner circumferential surface of the first support section 42 of the cover member 41 makes contact with the outer circumferential surfaces of the resonant conductor tube 12 and the ground conductor tube 13 and these tubes 12 and 13 are fixed to the first support section 42 of the cover member 41, and the second support section 43 of the cover member 41 makes contact with the exposed portion 20 of the feeding section 18A and the exposed portion 20 is fixed to the second support section 43. The portions where the halves of the cover member 41 make contact with each other are fixed by an adhesive (not shown), and the cylindrical shape of the cover member 41 is maintained. Moreover, the halves are fixed with a screw (not shown), and the cylindrical shape is maintained.

It is clear that, as compared to the antenna 10A alone, as shown by a dotted line in FIG. 19, the usable frequency band of the antenna 40 with a cover expands at a lower frequency, the VSWR (voltage standing wave ratio) is 3 or less at the working frequency thereof, and the antenna 40 with a cover has a wide working frequency band in a state in which high VSWR (voltage standing wave ratio) is maintained. Incidentally, in the antenna 40 with a cover, the antenna that can be installed in the cover member 41 is not limited to the antenna of FIG. 1, and the antennas 10B and 10C of FIGS. 6 and 8 may be installed in the cover member 41 to obtain the antenna 40 with a cover.

In the antenna 40 with a cover, the working frequency band in the antenna 10A expands to a lower frequency band by the permittivity of the cover member 41, making it possible to expand further the working frequency band in the antenna 10A as compared to a case in which the cover member 41 is not used. The antenna 40 with a cover can transmit or receive radio waves in all the bands of the usable frequency band and can be used in a wide frequency band (a wide band).

### EXPLANATIONS OF LETTERS OR NUMERALS

10A antenna
10B antenna
10C antenna
11 unbalanced feed member
12 resonant conductor tube
13 ground conductor tube
14 connection conductor guide
15 first conductor
16 first insulator
17 second conductor
18A feeding section
18B feeding section
18C feeding section
18D feeding section
19 passive section
20 exposed portion
21 unexposed portion
22 exposed portion
23 unexposed portion
36 third conductor
37 third insulator
40 antenna with a cover
41 cover member
42 first support section
43 second support section
L3 distance
L4 distance

1. An antenna comprising:
an unbalanced feed member; and
a conductor tube disposed on the outside of the outer circumferential surface of the unbalanced feed member, the unbalanced feed member including a feeding section having a predetermined length and a passive section leading to the feeding section and having a predetermined length,
wherein
the conductor tube is formed of a resonant conductor tube located on the outside of the feeding section of the unbalanced feed member and covering the feeding section and a ground conductor tube located on the outside of the passive section of the unbalanced feed member and covering the passive section,
the conductor tubes and the unbalanced feed member are electrically fixed via a fixing unit, and
the feeding section of the unbalanced feed member has an exposed portion with a predetermined size, the exposed portion exposed from the resonant conductor tube outward in the length direction thereof.

2. The antenna according to claim 1, wherein
the distance from the inner circumferential surface of the ground conductor tube to the outer circumferential surface of the passive section of the unbalanced feed member is in the range of 8 to 12 mm.

3. The antenna according to claim 1, wherein
the distance from the inner circumferential surface of the resonant conductor tube to the center of the feeding section of the unbalanced feed member is in the range of 4 to 10 mm.

4. The antenna according to claim 3, wherein
the distance from the inner circumferential surface of the ground conductor tube to the outer circumferential surface of the passive section of the unbalanced feed member is greater than the distance from the inner circumferential surface of the resonant conductor tube to the center of the feeding section of the unbalanced feed member.

5. The antenna according to claim 1, wherein
the unbalanced feed member is made of at least first and second conductors and a first insulator of the first conductor, the first insulator covering the outer circumferential surface of the first conductor, the second conductor covering the outer circumferential surface of the first insulator, and a second insulator covering the outer circumferential surface of the second conductor,
the feeding section of the unbalanced feed member is formed of the first conductor and the first insulator, and
the passive section of the unbalanced feed member is formed of at least the first and second conductors and the first insulator of the first and second conductors and the first and second insulators.

6. The antenna according to claim 5, wherein
in the feeding section of the unbalanced feed member, a predetermined length of the first conductor is exposed outward from the first insulator in the length direction thereof.

7. The antenna according to claim 6, wherein
to the first conductor exposed from the first insulator in the feeding section, a third conductor having a predetermined length is electrically fixed.

8. The antenna according to claim 6, wherein
to the first conductor exposed from the first insulator in the feeding section, a third insulator having a predetermined length is fixed.

9. The antenna according to claim 1, wherein
the resonant conductor tube, the ground conductor tube, and the exposed portion of the feeding section are covered with a cover member having a predetermined permittivity.

10. The antenna according to claim 9, wherein
the cover member is made of thermoplastic synthetic resin.
